(19) United States
(12) Patent Application Publication
(10) Pub. No.: US 2014/0284456 A1
(43) Pub. Date: Sep. 25, 2014

(54) RADIATION DETECTION APPARATUS AND RADIATION DETECTION SYSTEM

(71) Applicant: CANON KABUSHIKI KAISHA, (US)

(72) Inventors: Satoshi Okada, Tokyo (JP); Shoshiro Saruta, Tokyo (JP)

(73) Assignee: CANON KABUSHIKI KAISHA, Tokyo (JP)

(21) Appl. No.: 13/840,870

(22) Filed: Mar. 15, 2013

(30) Foreign Application Priority Data
Mar. 29, 2012 (JP) 2012-076775

(51) Int. Cl. G01J 1/42; G01T 1/16

(52) U.S. Cl. CPC G01J 1/42; G01T 1/16
USPC 250/208.2

(57) ABSTRACT

A radiation detection apparatus includes a substrate; a pixel area constituted of one or more pixels including a sensor element on the substrate; and a light source, wherein the light source is disposed at a side of the substrate in which the pixel area is disposed and outside of the pixel area, and light from the light source is incident on the sensor element.

### BACKGROUND OF THE INVENTION

1. Field of the Invention

The present invention relates to radiation detection apparatuses, and in particular, to a radiation detection apparatus and a radiation detection system for use in a medical X-ray diagnostic apparatus, a nondestructive inspection apparatus, and the like that use a photoelectric conversion unit. In this specification, “light” includes not only visible light, ultraviolet light, and infrared light but also radiations, such as X-rays and γ-rays.

2. Description of the Related Art

As the digital technology progresses in the recent years, radiation detection apparatuses that handle X-ray images as digital data have been researched and developed extensively. Radiation detection apparatuses that handle X-ray images as digital data are classified into direct conversion and indirect conversion systems. A direct system (direct conversion system) is one in which X-rays are directly converted to an electrical signal by a photoelectric conversion element having sensitivity to an X-ray waveband. On the other hand, an indirect system (indirect conversion system) is one in which X-rays are converted to visible light with phosphor, and then the converted visible light is converted to an electrical signal by a photoelectric conversion element having sensitivity to the visible light waveband. In both of the direct conversion and indirect conversion systems, the electrical signals are digitized and read by specialized semiconductor circuitry.

Digitizing an image allows the image to be recorded on various media types, which makes it easy to store, search for, and transfer and distribute the image, thus enhancing the efficiency in terms of management and operation in medical establishments, such as hospitals. Furthermore, obtaining image information as digital values allows high-level image processing to be performed by a computer at high speed, and thus improvement in diagnosis accuracy can be achieved.

In general, in the case where a photoelectric conversion element is formed of the main material of an amorphous silicon semiconductor, defect levels are formed due to a dangling bond in the amorphous semiconductor film or impurities mixed in the forming process. Dangling bonds act as carrier (electrons or holes) trap levels, in which electrons or holes are trapped. After a lapse of few milliseconds to tens of seconds after a power source is turned on, the trapped carriers are thermally excited into the conduction band or the valence band to cause a dark current. The dark current causes a decrease in signal-to-noise (S/N) ratio, which is a measure of the quality of the signal in a circuit. It is said that the trap levels, which are one of causes of the dark current, are often present particularly in the interface between a semiconductor layer and a blocking layer.

It is believed that in the case where not an amorphous semiconductor film but a crystalline MIS-type photoelectric conversion element is used, the number of trap levels is not larger than that with the amorphous semiconductor film, although depending on the process conditions and the device to be produced. However, mismatching between crystal lattices (lattice misfit, lattice defect, etc.) occurs in the interface between the semiconductor layer and the blocking layer, where the number of trap levels is not zero, so that a certain degree of dark current flows. This dark current causes a decrease in S/N ratio.

One conceivable driving method for a radiation detection apparatus for reducing the dark current is a method for performing photoelectric conversion after the dark current is reduced after a lapse of a few seconds to tens of seconds since bias voltage is applied to the photoelectric conversion elements or switching elements. However, application of this method to a radiation detection apparatus has problems of increasing the interval between image acquisitions and decreasing the ease of use of the apparatus. In particular, in the case where X-rays are repeatedly radiated onto a detector to form a moving image, a problem occurs in that the dark current cannot be sufficiently reduced in the short time between the repeated radiation emissions to the detector.

To address such problems, a known apparatus reduces noise in image information, such as an afterimage due to trapped electrons or holes, by irradiating photoelectric conversion elements with light having a wavelength included in a waveband in which the photoelectric conversion elements are sensitive thereto. A known specific example is a radiation detection apparatus configured such that a light source having an emission wavelength in an optical absorption wavelength region of each photoelectric conversion element, such as an LED (light-emitting diode) and an EL (electroluminescence) diode, is provided at the back of the light-receiving surface of the photoelectric conversion element so that the light from the light source irradiates the light-receiving surface of the photoelectric conversion element.

U.S. Patent Application Publication No. 2002/0024016 discloses a radiation detection apparatus including a converting section in which photoelectric conversion elements are disposed in array on a first surface of a substrate and a light source disposed on a second surface of the substrate facing the first surface or a side next to the first surface of the substrate. Furthermore, a wavelength converter that converts radiation to light that the photoelectric conversion elements can detect is provided at the opposite side of the photoelectric conversion elements from the substrate.

U.S. Pat. No. 4,980,553 discloses a radiation detection apparatus including photoelectric conversion elements disposed on a substrate and a light source disposed between the substrate and the photoelectric conversion elements. Furthermore, a wavelength converter that converts radiation to light that the radiation photoelectric conversion elements can detect is disposed on the photoelectric conversion elements.

U.S. Patent Application Publication No. 2009/0283685 discloses a radiation-image detector including a photoelectric conversion element disposed on a substrate, a wavelength converter disposed on the photoelectric conversion element, and a light source disposed on the wavelength converter.

The configurations of the related art, described above, have the following problems to be solved:

(1) The configuration of U.S. Patent Application Publication No. 2002/02024016 is such that the light source protrudes to the side or back of the substrate (also referred to as a sensor substrate), and thus, the radiation detection apparatus has a large size.

(2) The configuration of U.S. Pat. No. 4,980,553 is such that the photoelectric conversion elements are prone to be influenced by noise due to the light source because of the disposition of the light source and the photoelectric conversion elements, thus causing an unstable image.

(3) The configuration of U.S. Patent Application Publication No. 2009/0283685 is such that the light from the light source is absorbed, scattered, or the like in the optical path due to the wavelength converter, and thus, the light that reaches the photoelectric conversion element can be attenuated.

The present invention provides a compact radiation detection apparatus which is less influenced by noise due to the light source and in which the light is less attenuated.

### SUMMARY OF THE INVENTION

A radiation detection apparatus includes a substrate; a pixel area constituted of one or more pixels including a sensor element on the substrate; and a light source, wherein the light source is disposed at the side of the substrate in which the pixel area is disposed and outside the pixel area, and light from the light source is incident on the sensor element.

The present invention can provides a compact radiation detection apparatus which is not influenced by noise due to a light-source power source and in which attenuation of light due to the components is small.

Further features of the present invention will become apparent from the following description of exemplary embodiments with reference to the attached drawings.

### BRIEF DESCRIPTION OF THE DRAWINGS

FIG. 1 is a cross-sectional view of a radiation detection apparatus of a first embodiment;

FIG. 2 is a plan view of the radiation detection apparatus of the first embodiment;

FIG. 3 is a cross-sectional view of a radiation detection apparatus of a second embodiment;

FIG. 4 is a cross-sectional view of a radiation detection apparatus of a third embodiment;

FIG. 5 is a plan view of the radiation detection apparatus of the third embodiment;

FIG. 6 is a cross-sectional view of a radiation detection apparatus of a fourth embodiment;

FIG. 7 is a cross-sectional view of a radiation detection apparatus of a fifth embodiment;

FIG. 8 is a plan view of the radiation detection apparatus of the fifth embodiment;

FIG. 9 is a cross-sectional view of a radiation detection apparatus of a sixth embodiment;

FIG. 10 is a cross-sectional view of a radiation detection apparatus of a seventh embodiment;

FIG. 11 is a cross-sectional view of a radiation detection apparatus of an eighth embodiment;

FIG. 12 is a cross-sectional view of a radiation detection apparatus of a ninth embodiment;

FIG. 13 is a cross-sectional view of a radiation detection apparatus of a tenth embodiment; and

FIG. 14 is a schematic diagram illustrating a radiation detection system using a radiation detection apparatus.

### DESCRIPTION OF THE EMBODIMENTS

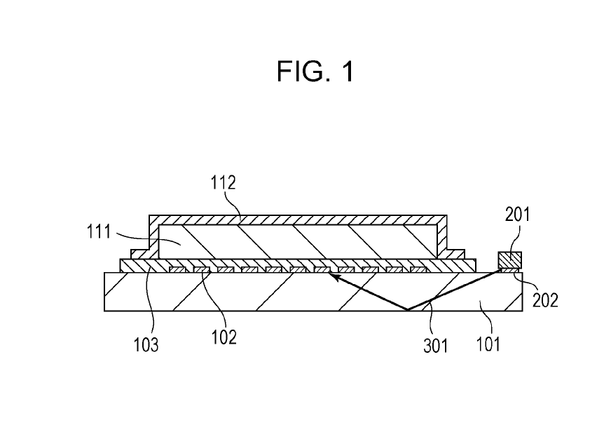

Although embodiments of the present invention will be described in detail with reference to FIGS. 1 to 13, the present invention is not limited by the embodiments.

### First Embodiment

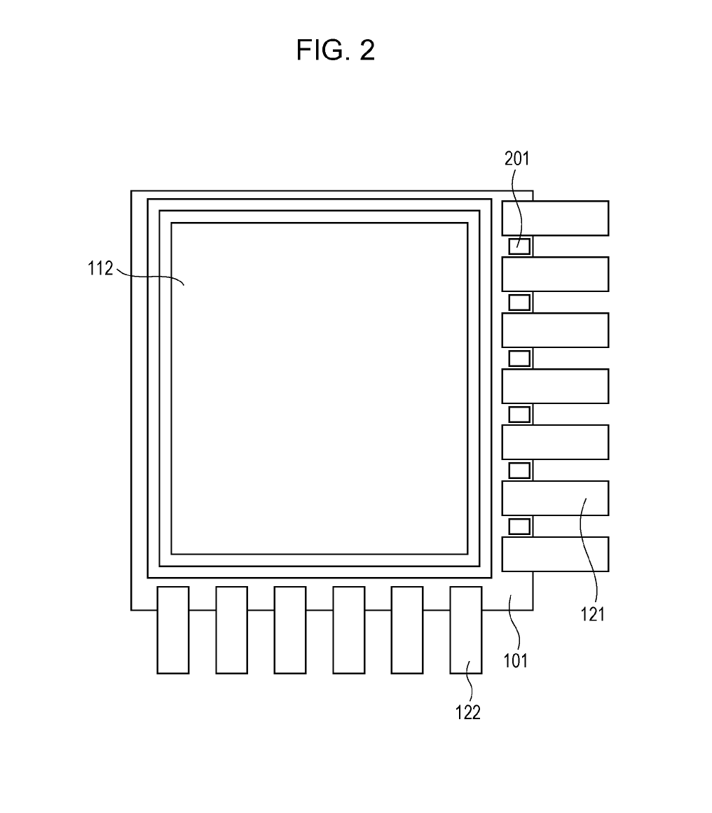

FIG. 1 is a cross-sectional view of a radiation detection apparatus according to a first embodiment. FIG. 2 is a plan view thereof.

The radiation detection apparatus includes a light-transmissive substrate (also refereed to as a sensor substrate) 101, photoelectric conversion elements 102 serving as sensor elements, a sensor protecting layer 103 for protecting the photoelectric conversion elements 102, a wavelength converter 111 for converting radiation to visible light, a wavelength-converter protective layer 112 for protecting the wavelength converter 111. In the first embodiment, the photoelectric conversion elements 102 are disposed on the substrate 101 and have sensitivity to visible light. The wavelength converter 111 is disposed on the photoelectric conversion elements 102.

The wavelength-converter protective layer 112 may include a reflecting layer that reflects light emitted from the wavelength converter 111. The photoelectric conversion elements 102 are photoelectric conversion elements having a function of converting the light emitted from the wavelength converter 111 to an electrical signal. Although MIS-type and PIN-type sensor elements are known, another configuration that converts light from the wavelength converter 111 to an electrical signal is possible. The photoelectric conversion elements 102 may be a combination of a sensor with the MIS structure or the PIN structure and a switch, such as a thin film transistor (TFT). Furthermore, a direct conversion type in which radiation is directly converted to an electrical signal can also be used.

Reference numeral 201 denotes a light source, 202 denotes a bump for mounting the light source 201 to establish electrical connection, and 301 denotes the optical path of light emitted from the light source 201. Reference numeral 121 in FIG. 2 denotes an electrical component D for transmitting a signal from an external driving circuit board (not shown) to the substrate 101. Reference numeral 122 in FIG. 2 denotes an electrical component A for transmitting a signal from the photoelectric conversion element 102 to an external circuit board (not shown). In FIG. 1, the electrical components D 121 and A 122 are omitted.

The electrical components are electrical-signal transmitting members for use in tape automated bonding (TAB) or the like. The electrical signal is an electrical signal, such as a signal from a power source for driving the photoelectric conversion elements 102 serving as sensor elements and a signal detected by the photoelectric conversion elements 102.

The light sources 201 are provided mainly to reduce noise in image information, such as an afterimage due to trapped electrons or holes, by irradiating the photoelectric conversion elements 102 with light.

To reduce the noise, the light sources 201 needs to have a light-emitting wavelength in the optical absorption wavelength region of the photoelectric conversion elements 102. Therefore, in the case where amorphous silicon is used as active layers of the photoelectric conversion elements 102, it is preferable to select wavelengths from 500 nm to 700 nm. The light sources 201 may be disposed on the substrate 101 and outside an area in which the sensor elements (photoelectric conversion elements) 102 are disposed (also referred to as a pixel area).

In some embodiments of the present invention, one unit of a light detection region formed of at least one photoelectric conversion element 102 is referred to as a pixel. An area constituted of one or more pixels including the photoelectric conversion element 102 is referred to as a pixel area.

As indicated by the optical path 301, the light from the light source 201 enters the substrate 101, is reflected at the interface (the back of the substrate 101 in FIG. 1) between the substrate 101 and the outside of the substrate 101 (typically the atmosphere), and reaches the photoelectric conversion element 102.

Since the light that has entered the substrate 101 is reflected at the interface between the substrate 101 and the outside of the substrate 101, the radiation detection apparatus is designed so that the light reaches the photoelectric conversion element 102, as indicated by the optical path 301. In other words, the radiation detection apparatus is configured such that at least part of the substrate 101 functions as a light waveguide (optical path).

Although the optical path is indicated by the optical path 301 for the sake of convenience, the light from the light source 201 is radiated in various directions below the light source 201. Therefore, the light through the optical paths repeats reflection at individual interfaces and thus reaches all the photoelectric conversion elements 102 on the substrate 101.

The interface (the surface, the back, or the side of the substrate 101) between the substrate 101 and the outside of the substrate 101 (typically the atmosphere) may be provided with a reflecting surface (or a reflecting member) for efficiently reflecting light into the substrate 101 or surface roughness (diffusion reflecting portion) for diffusely reflecting the light as necessary. This can further uniformize the distribution of light incident on the photoelectric conversion elements 102. Here, the diffused reflection refers to reflection of light from a rough surface, at which incident light is reflected at various angles, and is also referred to as irregular reflection.

Providing a member for diffusely reflecting light on the interface (the surface, the back, or the side of the substrate 101) between the substrate 101 and the outside of the substrate 101, in addition to the substrate 101, can provide the same advantages. Specifically, a reflecting portion or a diffusion reflecting portion may be provided, or a reflecting member or a diffusion reflecting member may be joined to at least one selected from a surface of the substrate 101 on which the pixel area is disposed, a surface opposite from the surface on which the pixel area is disposed, and a side.

The property of the diffusion reflecting portion may have distribution. This can further uniformize the distribution of the intensity of the diffused light. For example, the property of the diffusion reflecting portion can be distributed by, for example, changing the shape or size of the surface roughness and the form of distribution of the diffusion reflecting portion (or the diffusion reflecting member: a member having a diffusion reflecting portion) depending on the light diffusion or scattering characteristics.

Furthermore, providing an optical-path changing member that guides the light from the light source 201 to the substrate 101 can increase the design flexibility of the optical path. Examples of the optical-path changing member include a lens, a prism, a mirror, and an optical fiber.

Furthermore, the reflecting surface, the reflecting member, the diffusion reflecting portion, or the diffusion reflecting member may have an electromagnetic shield function. Specifically, forming the reflecting surface, the reflecting member, the diffusion reflecting portion, and the diffusion reflecting member from a metallic material can provide an electromagnetic shield function, in addition to the light diffusion reflecting function. However, also in the case where the reflecting surface, the reflecting member, the diffusion reflecting portion, or the diffusion reflecting member is given the electromagnetic shield function, it is necessary to transmit X-rays efficiently to make the X-rays reach the wavelength converter 111 (or the photoelectric conversion element 102). Examples of a metallic material having such functions include silver (Ag), aluminum (Al), and gold (Au).

Some of the light from the light sources 201 is directly incident on the photoelectric conversion elements 102 from therebelow (below in FIG. 1), and some of the light once passes between the photoelectric conversion elements 102 and is reflected by the sensor protecting layer 103 thereon, the wavelength converter 111, or the wavelength-converter protective layer 112 to reach the photoelectric conversion elements 102 from thereabove (not shown).

According to some embodiments of the present invention, since the light sources 201 are disposed on the portion (sensor element side) of the substrate 101 other than the sensor element area (pixel area), the following advantages are provided:

(1) There is no need to ensure an additional volume, as compared with a configuration in which light sources are disposed below or at the side of the substrate, thus allowing a thinner, compact design.

(2) The influence of noise on the substrate due to changes in light-source driving voltage or the like can be reduced, as compared with a configuration in which light sources are provided between the sensor elements and the substrate.

Attenuation of light from light sources due to absorption or scattering of part of the light can be reduced, as compared with a configuration in which the light sources are provided on the wavelength converter.

Disposing the light sources 201 on the surface of the substrate 101 on which the photoelectric conversion elements 102 are disposed and outside the region of the substrate 102 in which the photoelectric conversion elements 102 are disposed eliminates obstruction to irradiation of the photoelectric conversion elements 102 with radiation. This may be applied particularly to a radiation detection apparatus configured such that radiation is applied to sensor elements from a radiation source located at the surface of the substrate opposite from the surface on which the sensor elements are disposed.

The light sources 201 may be any light sources that emit light having a wavelength that the photoelectric conversion elements 102 absorb, such as an LED, a laser light source, and an EL sheet. A power source for driving the light sources 201 may be directly wired from the outside (not shown).

Electrical energy for driving the light sources 201 may be supplied from a power source substrate (not shown) through the electrical component D 121 or the electrical component A 122. The electrical energy may be supplied through a wire line (not shown) provided on the substrate 101.

The electrical components D 121 and A 122 having wire lines for supplying electrical energy may have wire lines for removing noise between them and wire lines for controlling the photoelectric conversion elements 102. The wire lines may be fixed at a constant potential.

The substrate 101 equipped with a wire line for supplying electrical energy may have a wire line for removing noise between it and a wire line for controlling the photoelectric conversion elements 102. The wire line may be fixed at a constant potential.

The light sources 201 may be provided on the electrical components D 121 or the electrical components A 122. In this case, the electrical components D or A may each be provided with a window (or opening) for light to pass therethrough or may be made of a light-transmitting material.

If LEDs are used as the light sources 201, flip-chip bonding may be used. As an alternative, an EL element may be directly formed on the substrate 101. Here, “directly formed on the substrate” includes not only a configuration in which the EL element is directly formed on the substrate but also a configuration in which the EL element is integrally formed with the substrate (the EL element is formed separately from the substrate and then assembled into the substrate).

“Integrally formed with the substrate” refers to a state in which the substrate and the EL element are substantially integrated with each other (inseparably configured). For example, the EL element can be integrally formed with the substrate by forming electrodes, a light-emitting portion, and so on one after another, by embedding a separately formed EL element into the substrate, by laminating the EL element by bonding or with resin.

This includes a case where an intermediate layer formed of an electrically conductive material or an insulating material is interposed between the substrate and the EL element as necessary. Also in this case, electrical energy for driving the EL element may be supplied from the electrical component D or the electrical component A (not shown). The electrical energy may also be supplied through a wire line provided on the substrate or the sensor element (not shown).

Providing the light sources 201 on the portion of the substrate 101 other than the sensor element area (sensor element side) eliminates needless protrusion of the light sources 201, thus allowing a compact design of the radiation detection apparatus.

Setting the height of the light sources 201 lower than or equal to the height of the upper surface of the wavelength-converter protective layer 112 if possible allows a compact design of the radiation detection apparatus. By not protruding the light sources 201 from the side of the substrate 101, the radiation detection apparatus can be made more compact. Furthermore, as shown in FIG. 2, disposing the light sources 201 between the electrical components D 121 within the width of the joint portion between the electrical components D 121, the radiation detection apparatus can be made yet more compact. In this case, the light sources 201 are not disposed at the signal side where they are relatively prone to be influenced by noise. In other words, the light sources 201 may be disposed at a position where they are less influenced by noise.

Examples of the material of the wavelength converter 111 are all materials that generate an electromagnetic wave having a wavelength that the photoelectric conversion element 102 can detect from radiation, such as GOS (gadolinium compound (Gd₂O₂S: Tb)) and CsI.

An example of the wavelength-converter protective layer 112 may have a configuration in which hot melt resin with a thickness of 50 μm is disposed at the aluminum surface side of an Al/PET sheet in which Al 20 μm in thickness and PET 12 μm in thickness are layered and may include a reflecting layer that reflects light from the wavelength converter 111.

The radiation may be introduced either from the wavelength converter 111 side or from the substrate 101 side. To reduce damage to the light sources 201 due to radiation, a radiation shielding member (not shown) may be provided at the radiation incident side of the light sources 201.

As described above, according to the first embodiment, a compact radiation detection apparatus which is not influenced by noise due to the power source for the light sources 201 and in which attenuation in light due to the components is small.

### Second Embodiment

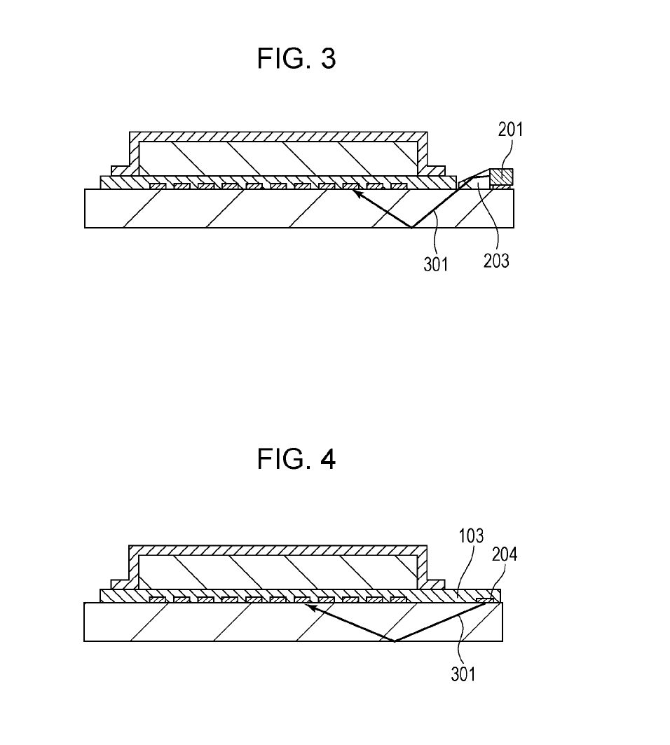

FIG. 3 is a cross-sectional view of a radiation detection apparatus according to a second embodiment. The radiation detection apparatus further includes an optical waveguide member 203 for efficiently introducing the light from the light sources 201 into the substrate 101.

Since the second embodiment uses LEDs that emit light in the lateral direction, the optical waveguide member 203 is provided at the side of the LEDs.

As indicated by the optical path 301, the light emitted from the light sources 201 enters the optical waveguide member 203, where the direction thereof is changed, and the light enters the substrate 101. In some embodiments of the present invention, the optical waveguide member 203 refers to a guide that controls the waveguide (optical path) of the light from the light sources 201 and efficiently introduces the light into the substrate 101. The optical waveguide member 203 may be a reflecting layer.

The optical waveguide member 203 used as a light waveguide may have a refractive-index matching layer (also referred to as an optical matching member) for reducing reflection loss due to the refractive index difference between the light sources 201 and the substrate 101. Here, “refractive-index matching layer” is a layer that reduces reflection of light due to the difference in refractive index between the materials of the light sources 201 and the substrate 101. The reflection loss due to the difference in refractive index can be reduced by, for example, interposing a material having the intermediate refractive index between the refractive index of a material that constitutes the light sources 201 and the refractive index of a material that constitutes the substrate 101 therebetween (at the joint). This configuration allows the light from the light sources 201 to be efficiently transmitted to the photoelectric conversion element 102.

### Third Embodiment

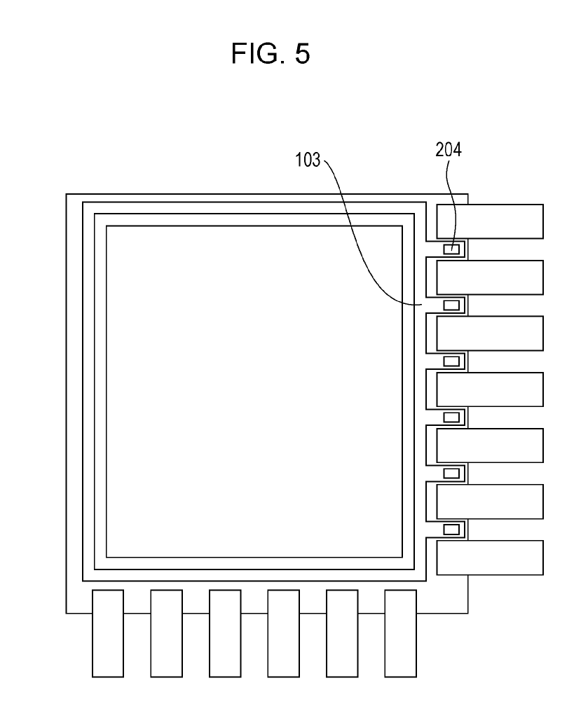

FIG. 4 is a cross-sectional view of a radiation detection apparatus according to a third embodiment. FIG. 5 is a plan view thereof.

EL diodes 204 are formed as light sources on the substrate 101. A known configuration can be employed for the EL diodes 204. The power for the EL diodes 204 is supplied from a power-source substrate (not shown) through wire lines formed on the electrical components D 121 and the substrate 101.

The EL diodes 204 may be protected by the protective layer 103 for protecting the photoelectric conversion element 102. As shown in FIG. 5, disposing each of the EL diodes 204 between the electrical components D 121 allows a more compact design in plan view.

### Fourth Embodiment

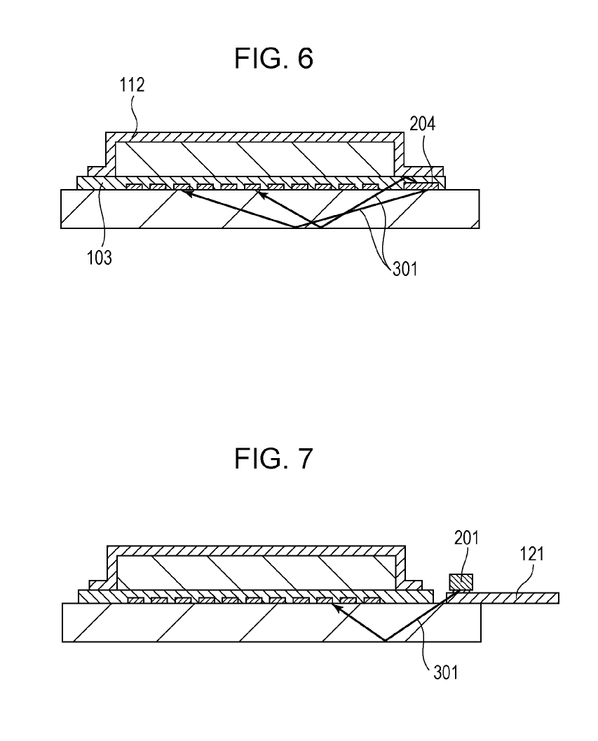

FIG. 6 is a cross-sectional view of a radiation detection apparatus according to a fourth embodiment.

The protective layer 112 for phosphor serving as the wavelength converter 111 is disposed above the light sources. The wavelength-converter protective layer (phosphor protective layer) 112 is equipped with a reflecting layer (not shown) that reflects both light from the wavelength converter 111 and the light from the light sources.

The light sources are the EL diodes 204 shown in the third embodiment. Since light is emitted from the EL diodes 204 vertically in the plane of the drawing, the configuration of the fourth embodiment allows the light emitted upward to be reflected downward, thus enhancing the light use efficiency.

The light sources are not limited to the EL diodes 204; any light sources that emit light also upward (for example, a laser light source, an LED, and an EL sheet) may be employed.

### Fifth Embodiment

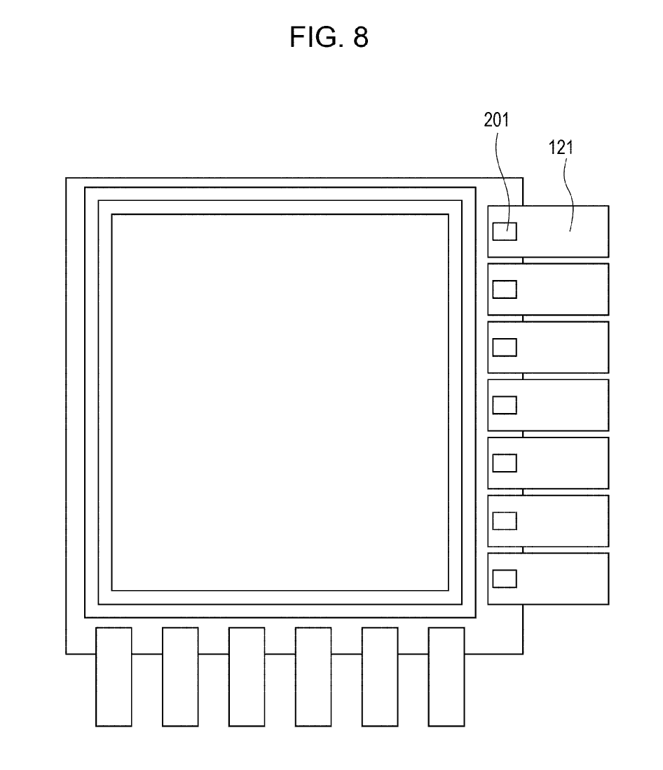

FIG. 7 is a cross-sectional view of a radiation detection apparatus according to a fifth embodiment. FIG. 8 is a plan view thereof.

The LED light sources 201 are disposed as light sources on the individual electrical components D 121. The light sources 201 are mounted on the electrical components D 121 by flip-chip bonding. The electrical components D 121 may be mounted on the substrate 101, with the light sources 201 are mounted thereon in advance, or alternatively, after the electrical components D 121 are mounted on the substrate 101, the light sources 201 may be mounted on the electrical components D 121.

The electrical components D 121 directly under the light sources 201 each have a window for introducing light (not shown) into the substrate 101.

### Sixth Embodiment

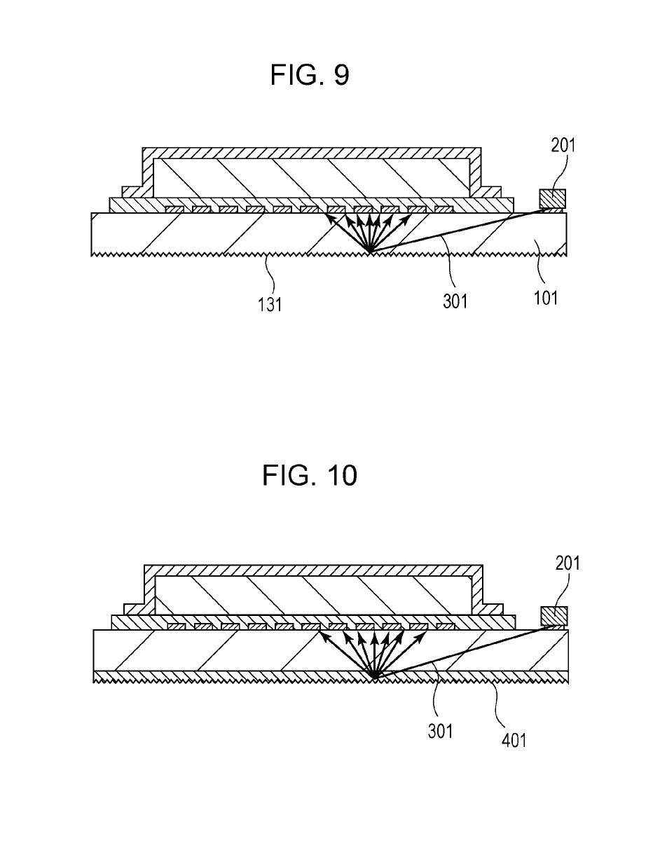

FIG. 9 is a cross-sectional view of a radiation detection apparatus according to a sixth embodiment.

The back of the substrate 101 is formed into a rough surface 131 to diffusely reflect the light.

This allows the light that has reached the back from the light sources 201 to be diffused as indicated by the optical path 301 to reach the plurality of photoelectric conversion elements 102.

The roughing of the back can be performed using a known method, such as etching and blasting. By distributing the degree of roughing in the surface depending on the quantity distribution of light that reaches the photoelectric conversion elements 102, the quantity distribution of light incident on the photoelectric conversion elements 102 can be further uniformized.

### Seventh Embodiment

FIG. 10 is a cross-sectional view of a radiation detection apparatus according to a seventh embodiment.

The seventh embodiment is configured to diffusely reflect the light, as in the sixth embodiment, but differs from the sixth embodiment in that a diffusion reflecting sheet 401 serving as a reflecting member is bonded to the back of the substrate 101.

The diffusion reflecting sheet 401 is formed of an organic material, such as resin, an inorganic material, a metallic material, or the like subjected to roughing. Examples of the metallic material include silver (Ag), aluminum (Al), and gold (Au). Also fine particles (for example, glass particles, particles coated with metal, and metal particles) hardened into a sheet form and a support member coated with particles may be used. A reflection enhancing film formed of ZnO or the like may be laminated to adjust the angle or optical path length of the reflected light as necessary. The diffusion reflecting sheet 401 is fixed with an adhesive or the like. By distributing the degree of roughness of the reflecting member, such as the diffusion reflecting sheet 401, in the surface, the quantity distribution of light incident on the photoelectric conversion elements 102 can be further uniformized.

### Eighth Embodiment

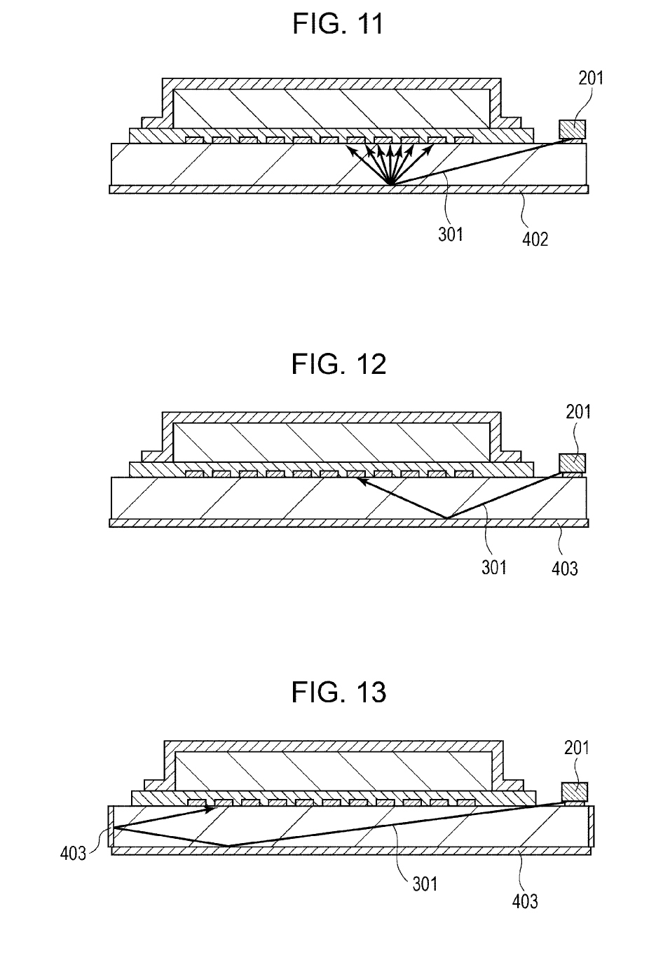

FIG. 11 is a cross-sectional view of a radiation detection apparatus according to an eighth embodiment.

A diffusion reflecting layer 402 serving as a reflecting member is provided on the back of the substrate 101. The diffusion reflecting layer 402 can be obtained by applying powder by using a spray or the like and hardening it as necessary. Examples of the powder for diffused reflection include known materials, such as TiO₂, Ta₂O₅, MgO, ZnO, and BaSO₄.

By changing the kind, color, and so on of the powder in the surface, the quantity distribution of light incident on the photoelectric conversion elements 102 can be further uniformized.

### Ninth Embodiment

FIG. 12 is a cross-sectional view of a radiation detection apparatus according to a ninth embodiment.

A reflecting layer 403 is provided on the back of the substrate 101. The reflecting layer 403 can be obtained by, for example, evaporating a thin film made of Al or the like. The sixth to ninth embodiments show configurations for diffusely reflecting light that has reached the back of the substrate 101, which can be combined as necessary.

### Tenth Embodiment

FIG. 13 is a cross-sectional view of a radiation detection apparatus according to a tenth embodiment.

The reflecting layer 403 is provided on the side of the substrate 101 in addition to the back to reduce leakage of light. The reflecting layer 403 can be obtained by, for example, evaporating a thin film made of Al or the like.

Since the tenth embodiment is a configuration for diffusely reflecting light that has reached the side of the substrate 101, the diffusion reflecting portions shown in the sixth to eighth embodiments may be used, or a combination thereof may be used.

### Application Example

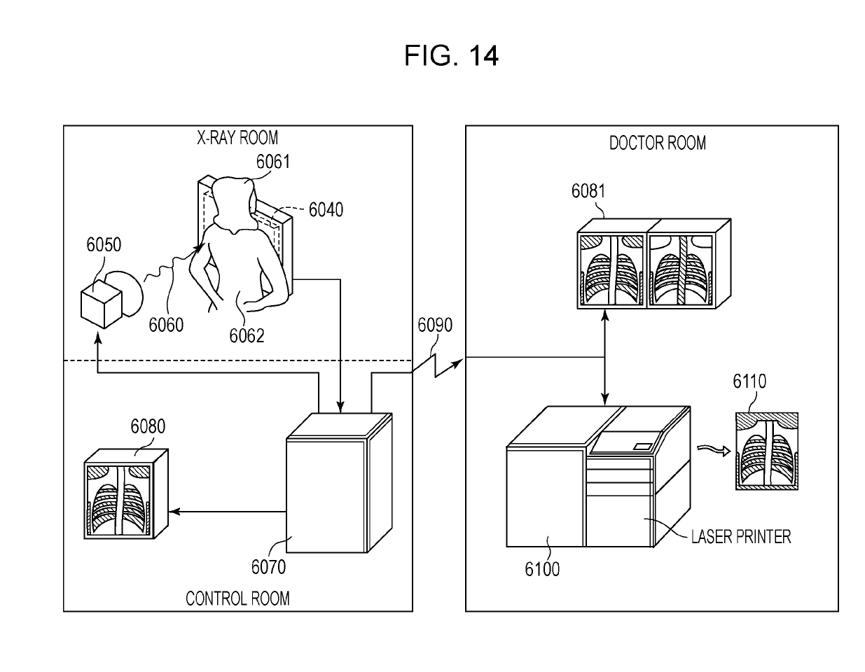

Referring next to FIG. 14, a radiation detection system that uses a detection apparatus according to an embodiment of the present invention will be described.

X-rays 6060 generated by an X-ray tube 6050 serving as a radiation source pass through a body part 6062 of a patient or a subject 6061 and enter conversion elements in a radiation detection apparatus 6040. The X-rays 6060, incident on the radiation detection apparatus 6040, include information on the interior of the body part 6062 of the patient 6061. The conversion elements convert the radiation to electric charges in response to the incoming X-rays to obtain electrical information. This information is converted into digital data, which is processed by an image processor 6070 serving as a signal processing unit, and can be observed with a display monitor 6080 serving as a display unit in a control room.

Furthermore, this information can be transferred to a remote site via a transmission processing unit, such as a wired or wireless network 6090, and can be displayed on a display monitor 6081 serving as a display unit in a doctor room in the site or can be stored in a recording medium, such as an optical disc, thus allowing a doctor in a remote site to diagnose it. The information can also be recorded on a film 6110 serving as a recording medium with a film processor 6100 serving as a recording unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-076775 filed Mar. 29, 2012, which is hereby incorporated by reference herein in its entirety.

What is claimed is:

1. A radiation detection apparatus comprising:
a substrate;
a pixel area constituted of one or more pixels including a sensor element on the substrate; and
a light source,
wherein the light source is disposed at a side of the substrate in which the pixel area is disposed and outside of the pixel area, and
wherein light from the light source is incident on the sensor element.

2. The radiation detection apparatus according to claim 1, wherein the light from the light source is incident on the sensor element, with at least part of the substrate as a waveguide.

3. The radiation detection apparatus according to claim 1, wherein the light source is at least one light source selected from an LED, a laser, and an EL sheet.

4. The radiation detection apparatus according to claim 3, wherein the light source and the substrate are integrally formed with each other.

5. The radiation detection apparatus according to claim 1, further comprising
an optical path changing member that guides the light from the light source into the substrate.

6. The radiation detection apparatus according to claim 1, further comprising
an optical matching member disposed between the light source and the sensor element.

7. The radiation detection apparatus according to claim 1, further comprising
a reflecting portion or a diffusion reflecting portion disposed on at least one surface selected from a surface of the substrate in which the pixel area is disposed, a surface opposite from the surface in which the pixel area is disposed, and a side.

8. The radiation detection apparatus according to claim 7, wherein the diffusion reflecting portion is a rough surface.

9. The radiation detection apparatus according to claim 7, wherein the diffusion reflecting portion is at least one selected from a diffusion reflecting sheet, powder, and a reflecting layer.

10. The radiation detection apparatus according to claim 1, further comprising
a wavelength converter disposed above the photoelectric conversion element.

11. A radiation detection system comprising:
the radiation detection apparatus according to claim 1;
a signal processing unit configured to process a signal from the radiation detection apparatus;
a recording unit configured to record a signal from the signal processing unit;
a display unit configured to display the signal from the signal processing unit; and
a transmission processing unit configured to transmit the signal from the signal processing unit.

12. The radiation detection system according to claim 11, further comprising
a radiation source that emits radiation toward the radiation detection apparatus,
wherein the radiation sources emits radiation to the sensor element from the surface of the substrate opposite from the surface in which the sensor element is disposed.
